(19) United States
(12) Patent Application Publication
(10) Pub. No.: US 2026/0298552 A1
(43) Pub. Date: Oct. 1, 2026

(54) Latent Heat Thermal Energy Storage Systems

(71) Applicant: Robert Bosch Gmbh, Stuttgart (DE)

(72) Inventors: John CHRISTENSEN, Elk Grove, CA (US); Daniel MAYER, Scotts Valley, CA (US); Weiqi JI, Mountain View, CA (US)

(21) Appl. No.: 19/092,376

(22) Filed: Mar. 27, 2025

(51) Int. Cl. F28D 20/02

(52) U.S. Cl. CPC F28D 20/026

(57) ABSTRACT

A latent heat storage module includes a first container and a second container structured to contain a slurry; the slurry comprising a first component configured to retain its liquid phase during operation of the module, and a second component which is a phase change material suspended in the first component; a device configured to transport the slurry from the first container to the second container; and a heat exchanger in contact with the device configured to pass heat to or from the slurry.

### TECHNICAL FIELD

The present disclosure relates to a latent heat thermal energy storage system including a latent heat energy material and methods of using the same.

### BACKGROUND

Thermal energy storage (TES) is a process of storing heat and cold energy for later or latent use. A TES system can store the energy for hours, days, or weeks. TES systems typically utilize a medium which is being cooled or heated. Such systems facilitate storage of excess energy produced by variable sources such as renewable sources of energy and enable access to the stored energy when demand is high. TES systems may thus help balance the grid and increase overall reliability of renewable energy systems.

### SUMMARY

In one embodiment, a latent heat storage module is disclosed. The storage module may include a first container and a second container structured to contain a slurry; the slurry comprising a first component configured to retain its liquid phase during operation of the module, and a second component which is a phase change material suspended in the first component; a device configured to transport the slurry from the first container to the second container; and a heat exchanger in contact with the device configured to pass heat to or from the slurry. The second component may be a solid-solid phase change material. The phase change material may have a phase transition temperature within an operating temperature range of the latent heat storage module. The first component may be not a phase change material within an operating temperature range of the latent heat storage module. The slurry may be a viscous gel having a viscosity of about 0.5-20 Pa/s. The device may be a positive displacement pump. The first component may be water. The second component may be an organometallic compound.

In another embodiment, a latent heat storage system is disclosed. The system may include a cooling apparatus; a latent heat storage module in fluid communication with the cooling apparatus comprising: a mixture comprising a first component configured to retains its liquid phase during operation of the module and a second component which is a phase change material suspended in the first component; a device configured to mechanically move the mixture from a first area of the module to a second area of the module; and a heat exchanger, in contact with the device, configured to pass heat to the mixture or extract heat from the mixture while the mixture is in transit between the first area and the second area. The mixture may be a slurry. The device may be a screw pump. The second component may be a solid-solid phase change material. The phase change material may have a phase transition temperature within an operating temperature range of the latent heat storage module. The first component may be not a phase change material within an operating temperature range of the latent heat storage module. The mixture may be a viscous gel having a viscosity of about 0.5-20 Pa/s. The cooling apparatus may be a heat pump.

In yet another embodiment, a latent heat storage module is disclosed. The module may include a first and second containers structured to contain a slurry, the slurry comprising: a first component configured to retain its liquid phase during operation of the module and a second component which is a phase change material suspended in the first component configured to change phase during operation of the module; and a heat exchanger in contact with the slurry configured to pass heat to or from the slurry. The module may include a pivoting component structured to pivot the module with a pivot angle of about 180 degrees. The second component may be a solid-solid phase change material. The phase change material may have a phase transition temperature within an operating temperature range of the latent heat storage module.

### BRIEF DESCRIPTION OF THE DRAWINGS

FIG. 1 shows a non-limiting example of a latent heat thermal energy system or module with a screw pump, according to one or more embodiments disclosed herein;

FIG. 2 shows a non-limiting example of a latent heat thermal energy system or module with a piston pump, according to one or more embodiments disclosed herein;

FIG. 3 shows a non-limiting example of a latent heat thermal energy system or module with a single container and an agitator, according to one or more embodiments disclosed herein;

FIG. 4 shows a non-limiting example of a latent heat thermal energy system or module with a branched heat exchanger arrangement, according to one or more embodiments disclosed herein;

FIG. 5 shows a non-limiting example of a pivotable latent heat thermal energy system or module utilizing gravity to transfer a slurry, according to one or more embodiments disclosed herein; and

FIG. 6 shows another non-limiting example of a pivotable latent heat thermal energy system or module, according to one or more embodiments disclosed herein.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Unless stated otherwise, the wt.% is based on the total weight of the substrate and the vol.% is based on the total volume of the substrate.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/- 5% of the value. As one example, the phrase “about 100” denotes a range of 100+/- 5, i.e. the range from 95 to 105. Generally, when the term “about” is used, it can be expected that similar results or effects according to the disclosure can be obtained within a range of +/- 5% of the indicated value. The term “substantially” may modify a value or relative characteristic disclosed or claimed in the present disclosure. In such instances, “substantially” may signify that the value or relative characteristic it modifies is within ± 0%, 0.1%, 0.5%, 1%, 2%, 3%, 4%, 5% or 10% of the value or relative characteristic.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise,” “consist of,” or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Energy generated from renewable resources (solar, wind, and hydro power) comes with a plethora of challenges. For example, utilization has been problematic because of the increasing mismatch between the time of high energy demand (e.g. cooling homes in the summer during the late afternoon/evening) and the time of high rates of electricity generation (e.g. from wind farms that tend to peak at night or photovoltaics that peak mid-day). Yet, energy from renewable resources has advantages such as being environmentally friendly by producing minimal greenhouse gas emissions, providing a sustainable energy source which will not be depleted, reducing energy costs, lowering dependence on fossil fuels. Furthermore, decoupling heat/cold generation from heat/cold consumption enables to shift noise emittance from heat/cold generators to other times than the time when heat/cold is consumed (e.g. generate noise and heat when nobody is at home and heat the home silently when residents are back home).

Thermal energy storage (TES) is a technology developed for storage of energy produced from renewable resources. TES helps conserve energy and increase energy efficiency. TES includes storage of thermal energy in the form of sensible heat, latent heat, or through thermochemical reactions. Sensible heat storage involves storage of thermal energy by heating or cooling a liquid or a solid medium. While readily available materials such as water, sand, molten salts, or rocks have been utilized, sensible heat storage requires relatively large volumes because of its low energy density. Sensible heat storage does not involve phase change of the materials used.

In contrast, latent heat energy storage has 3-5 times higher energy density than the sensible heat storage. Latent heat storage utilizes heat absorption or release when a storage material undergoes a phase change from solid to liquid, liquid to gas, or solid to gas, and vice versa. Latent heat storage thus works as a “heat battery” to balance energy demand and supply by storing excess heat form an energy source for use when the energy is not being generated. Latent heat storage may be used for heating and cooling in buildings, vehicle interiors, or industrial processes. For example, latent heat storage may store heat from solar panels to be used for space heating during a cold period. Latent heat storage may store waste heat from industrial processes for later use in other applications. Latent heat storage may store thermal energy from concentrated solar radiation to generate electricity when the sun is not shining.

Latent heat storage is thus a relatively safe and convenient method of energy storage when incorporated into thermal systems such as air conditioners and heat pumps. Latent heat storage is also financially superior in comparison to conventional battery energy storage.

Many traditional latent heat storage systems utilize phase-change materials (PCM) such as solid to liquid or solid to solid. A PCM is a substance that absorbs and releases energy in the form of heat when it changes its physical state. For example, when the renewable energy such as solar energy is captured, the PCM absorbs heat and melts, changing phase from solid to liquid, storing the energy as latent heat. When needed, the stored heat is released as the PCM solidifies again.

But many typical latent heat storage materials and systems face difficulties. Specifically, traditional PCMs are challenging to cycle repeatedly because it is difficult to maintain good contact between the PCM and the heat exchanger after several or many cycles. A proper contact is required to ensure rapid heat transfer. Additionally, PCMs in the solid phase tend to be poor thermal conductors and/or succumb to material degradation. Furthermore, phase segregation in mixed systems may occur in the multiple phase change cycles for many of the PCMs.

Therefore, there is a need for an improved latent heat thermal storage system and latent heat storage materials.

In one or more embodiments, a thermal energy storage (TES) material is disclosed herein. The material may be a latent heat thermal storage material. The material may be a slurry. For the purposes of this application, a slurry is not a random mixture of a liquid and a solid; a slurry is a mixture of denser solid particles suspended in a liquid. The liquid functions as a carrier for the solids. In the slurry disclosed herein, the solid particles remain dispersed throughout the liquid, giving the slurry a fluid-like consistency such that the slurry is flowable like a liquid. The solid particles do not dissolve in the liquid, the solid particles are insoluble in the liquid. The liquid is not a solvent for the solid particles. The solid particles are a dispersed phase and the liquid is a continuous phase.

The slurry may include a blend or a mix of a first component and a second component. The first component may be a fluid/liquid carrier for the second component. The second component is a phase-change material (PCM). The fluid/liquid is a carrier for the PCM. The fluid/liquid is not a PCM and/or is not intended to be a PCM during the operating conditions. The fluid/liquid does not undergo a phase change during the temperature range and operating conditions of the herein-disclosed modules and systems at which the PCM undergoes a phase change (phase transition temperature). Therefore, the slurry may maintain the consistency and molecular structure of a slurry during the latent heat storage process while the PCM incorporated within the slurry undergoes phase changes during cycling. The slurry thus includes the first component, the fluid/liquid, which does not change its phase while the second component, the PCM, undergoes a phase change during operation of the herein-disclosed modules and systems.

The slurry thus includes at least a first volumetric portion which retains its phase throughout the entire latent heat storage process. The slurry includes at least a second volumetric portion which changes its phase during the latent heat storage process. The volumetric portions are miscible. The second volumetric portion is dispersed in the first volumetric portion and does not dissolve in the first volumetric portion. The first and second components may retain their respective volumes. Even when the second component changes its phase to a liquid, the liquid of the second component forms a separate volumetric portion from the first volumetric portion of the first component, which is a liquid. During the processes described herein, an overall volumetric content of a liquid in the slurry may fluctuate due to PCM’s phase change into a liquid, but the slurry retains its volumetric portion of the first component at all times. The slurry thus includes the first component, a liquid/fluid, at all times. The slurry may potentially also include a liquid from the PCM after its phase change to a liquid.

The PCM may have a first phase transition temperature. The fluid/liquid may have a second phase transition temperature. The second phase transition temperature is different than the first phase transition temperature. The second phase transition temperature may be higher or lower than the first phase transition temperature. The system operates within a temperature range. The temperature range includes the first phase transition temperature but does not include the second phase transition temperature. The second phase transition temperature is outside of the temperature range at which the system operates.

A non-limiting example fluid/liquid carrier in the slurry may include water, water-glycol mixture, ethylene glycol-water mixture, propylene glycol-water mixture, ammonia, formamide, fluorinated fluids, silicone oils, or their combination. The water may include deionized water, distilled water, treated water, or tap water. The fluid/liquid carrier is provided as an additional heat transfer medium to help increase the heat transfer rate between the heat exchange walls and the solid fraction of the PCM. The additional liquid/fluid helps the mechanical actuation of the slurry once the PCM is mostly solid. The liquid/fluid thus prevents a limitation of the charge window of the PCM and of the heat transfer rates compared to a system where a moveable slurry is not present over the entire state of charge (SOC) window. As a practical result, the presence of the fluid/liquid carrier enables actuation of the slurry/PCM over the entire SOC window, lowering the required amount of a needed working fluid connecting the TES heat exchanger to a heat pump.

The PCM may include a solid to solid (solid-solid) or a solid to liquid (solid-liquid) material. The solid-solid PCM may include materials that change their crystalline structure from one lattice configuration to another at a fixed and well-defined temperature. A non-limiting example solid-solid PCM may include one or more of organic compounds, organometallic compounds, inorganic compounds, and polymeric compounds such as cross-linking, side-chain grafting, block polymers, and hyper branching.

The solid-liquid PCM changes its internal molecular arrangement from an ordered crystalline structure to a disordered amorphous structure when a temperature exceeds a phase transition temperature. When the temperatures fall below the phase transition temperature, a nucleation process initiates arrangements of molecules into a crystalline lattice. A non-limiting example solid-liquid PCM may include one or more of organic compounds such as paraffins and fatty acids such as stearic acid, palmitic acid, lauric acid, capric acid, myristic acid, vegetable oils, sugar alcohols such as xylitol, sorbitol, erythritol, mannitol, galactitol and inorganic compounds such as salt hydrates such as sodium sulfate decahydrate, calcium chloride hexahydrate and metallics.

The slurry may be a viscous gel or a semi-solid slurry. The viscosity of the slurry may be about 0.5-20, 1-18, or 5-15 Pa/s. The viscosity may be about, at least about, or at most about 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20 Pa/s. The slurry may have a less viscous liquid state and a more viscous semi-solid state.

The slurry has better heat characteristics than traditional PCMs for several reasons. First, the slurry includes a fluid which may interface with a heat exchanger and ensure good contact for the PCM even if the PCM is in a solid state. The heat transfer efficiency for the herein-disclosed PCM material is thus better than traditional PCMs due to better surface compliance. In contrast, a traditional solid-solid PCM may not achieve a good contact with the heat exchanger upon solidification.

Second, the slurry may be movable mechanically. Hence, introduction of a slurry PCM enables a use of a larger reservoir, more compact heat exchanger, or both.

The slurry may have two states. In the first state, the “cold state,” the slurry has a lower temperature than a working fluid of the heat exchanger. In the second state, the “hot state,” the slurry has a higher temperature than the working fluid of the heat exchanger. In the hot state, the slurry may have a temperature higher than the phase transition temperature of the PCM component. In the cold state, the slurry may have a temperature lower than the phase transition temperature of the PCM component.

The material may be incorporated into a TES system, which may be a latent heat thermal storage system. The system may include one or more latent heat storage modules. The system may include a heat sink. The system may include a cooling or heating apparatus. The cooling or heating apparatus may include a heat pump, a heating apparatus, ventilation apparatus, air conditioning apparatus (HVAC), stationary energy storage system, or thermal management system including an electric vehicle thermal management system. A heat pump is a device using electricity to transfer heat from a cooler area to a warmer area, acting as both a heater and a cooler. The apparatus may be in a fluid communication with the system or module disclosed herein. The apparatus may be connected to the system or module via one or more components, for example a condenser for heating or an evaporator for cooling.

The system or module may include the slurry, a heat exchanger, and one or more devices. The one or more devices, the heat exchanger, the modules, the apparati, the systems, or their combination may be coupled fluidly, mechanically, or both between one another. The one or more devices may include one or more containers, tanks, reservoirs, vessels, cans, canisters, capsules, tubs, chambers, or receptacles. The containers may be latent heat thermal energy storage containers. The containers may contain the slurry. The slurry may be present in one of the containers or both containers at the same time. In a non-limiting example, the system may include the slurry in the hot state in the first container and in the cold state in the second container. The containers may include one or more openings configured as inlets, outlets, or both for ingress and egress of the slurry.

In another non-limiting example, the system or module may include a single container containing both the hot state slurry and the cold state slurry. The single container may include a barrier, such as a membrane or a flexible diaphragm, separating the hot state slurry from the cold state slurry while enabling pumping of the slurry between the two sides of the container. Alternatively, the container may be free of a barrier separating the hot state slurry from the cold state slurry. Instead, a mixer may be included in the container to circulate the slurry in the hot state and the cold state. In the same embodiment, a heat exchanger may be included in the volume of the slurry to transfer heat between the composite and the working fluid. Alternatively still, a single container may include the slurry as a heat exchanger for a homogenous heat transfer, with no mixer or agitator.

The advantage of a system or module with two containers may be an overall lower energy use for pumping the slurry (i.e., no recirculation required). The advantage of a single container includes minimizing the overall system size and decreasing an overall volume and complexity of the system. In a system with either one or more containers, recirculation of the volume(s) may be implemented. The containers may be modularized and may be replaceable, which enables customization of the system for different climate regions, conditions, different utility rate plans, etc.

The one or more devices may further include a mechanical actuator to mechanically move the slurry. A non-limiting example device may be a pump. The pump may be a positive displacement pump with one or more screws, a screw pump, a double screw pump, a rotor stator pump, or a piston pump.

The pump may include a housing such as a pipe or tube connecting the containers. The housing may be cylindrical or having a different shape. The housing may have an internal volume. The internal volume may have a round, circular, ellipsoidal, or another cross-section. For example, the shape of the cross-section of the internal volume may be defined by the shape of the pump casing. The housing such as a pipe may have a first end having a first internal diameter and a second end having a second internal diameter. The first and second internal diameters may be the same or different.

The housing may have an outer surface. The outer surface may be in direct contact with, be enclosed, fully or partially, with a heat exchanger. The heat exchanger may be arranged around the external surface of the housing. The heat exchanger is a device that transfers heat between a working fluid and the slurry without allowing them to mix directly. The working fluid and the slurry have different temperatures. Depending on the mode of the system – heating mode or the cooling mode – the working fluid increases or decreases its temperature by passing thermal energy through a separating wall to the slurry.

The heat exchanger includes the separating wall. The wall may be configured as a pipe or a tube in direct contact with the pump housing or a shell. For example, the wall may be a tube arranged, wrapped, or coiled around the pump housing. The heat exchanger may be internal, external, or both with respect to the container(s). The heat exchanger may include a heat transfer fluid or a working fluid, which flows through the heat exchanger. The heat exchanger may include one or more fins structured to enhance surface area and thus enhance heat transfer rates. The fins may be fractal-shaped such as tree-shaped fin structures. The heat exchanger may include one or more baffles structured to improve a contact of the working fluid to the heat exchanger surface. One or more components of the heat exchanger may include fractal geometry to increase heating/cooling homogeneity. The fractal geometry may include fractal channels, bifurcated channels as opposed to traditional channels which may result in higher heat transfer performance, lower pressure drop, and more uniform temperature distribution throughout the channels.

The pump housing’s internal volume may include one or more screws which are run by a motor and a driving spindle. The driving spindle may communicate with one or more idler spindles.

Alternatively, the system may be free of a pump to transport the slurry between the containers. The containers may be positioned such as to enable transport of the slurry through a connecting pipe between the containers via gravitational force. Alternatively still, the system or module may include a pump and use gravitational force. For example, the pump may recirculate the slurry to a higher elevation, but gravitational force may be used to transfer the slurry to a lower elevation.

Alternatively, the slurry may be moved from an upper cold state container to a lower hot state container, through a heat exchanger, via gravity, during the system’s heating mode. The system may be pivotable. The system may be thus physically rotated such that when the system transitions to the cooling mode, gravity may be used to move the hot state slurry from the upper container to the lower container. The system may be rotated from the heating mode to the cooling mode. An intermediate state of rotation may be set for the system when the system is in neither a heating nor cooling mode. The pivot angle of the system of module may be about, at least about, or at most about 45, 60, 90, 120, 180, 275, or 360 degrees.

The system or module may further include one or more pieces of hardware configured to enable transport of the slurry through the system or hold individual pieces of the system together, etc. such as bolts, mounting screws, seals, circlips, bearings, valves, the like, or their combination.

A non-limiting example of the system or module is shown in FIG. 1. FIG. 1 shows a latent thermal heat storage system or module 100. The system or module 100 includes a first container 102 and a second container 104 which are connected via a pump 106. The pump 106 includes a housing (pipe) 108, a screw 110, located within the housing, having a driving spindle 112, and a motor (not depicted). The system further includes a heat exchanger 114 in direct contact with the housing 108. The system 100 pumps the slurry 101 from the first container 102 to the second container 104 by engaging the slurry at the outlet of the first container 120 and moving the slurry via the pump 106 to the second container 104. The slurry 101 is drawn into spaces in between threads of the screw 110 and axially progresses towards the second container 104. Depending on the mode of the system, heat is either extracted from the working fluid in the heat exchanger 114 and provided to the slurry 101 for storage or extracted from the slurry 101 to the working fluid of the heat exchanger 114 to be provided to an apparatus such as a heat pump (not depicted).

In another non-limiting example, a latent heat thermal storage system or module 200 is shown. The system or module 200 may include two or more containers such as the first container 202 and a second container 204, which are in communication via a pump 206. The pump 206 may be a piston pump, non-limiting schematically depicted example of which is depicted in FIG. 2. The pump 206 may include a plurality of passive valves 220. The pump 206 further includes a piston 224. When the piston 224 is pressed, a first valve 221 closes while a second valve 222 opens such that the slurry 201 present in the body of the pump 206 is pushed to the second container 204. When the piston 224 moves up, the second valve 222 closes, the first valve 221 opens, and the slurry is sucked from the first container 202 to the body of the pump 206. A heat exchanger 114 is arranged around the body of the pump 206 through which the slurry travels. The heat exchanger 144 working fluid transfers heat to the slurry 201 or extracts heat from the slurry 201 as the slurry 201 flows through the body of the pump 206.

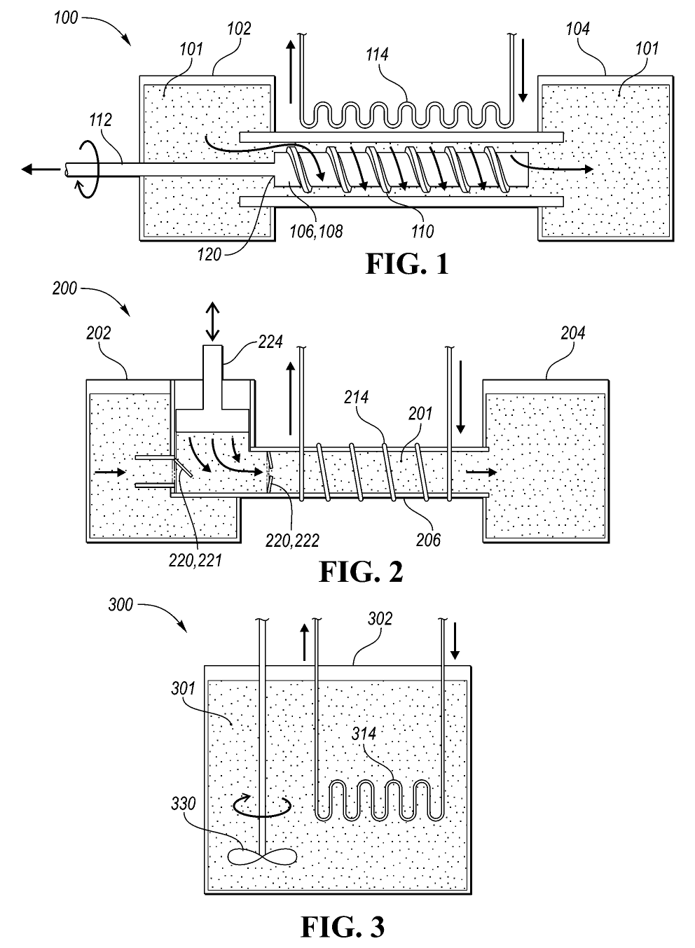

In another non-limiting example, a latent heat thermal storage system or module 300 is shown in FIG. 3. The system or module 300 includes a first container 302. The first container 302 may be the single or only container of the system 300. The container includes the slurry 301 which is being mixed by one or more agitators 330. The heat exchanger 314 is immersed within the slurry 301 in the container 302. The agitator(s) 330 may continuously agitate the slurry to obtain a uniform state of the slurry within the container 302. Alternatively, the heat exchanger 314 may be placed on the exterior of the container 302, similarly to the examples shown in FIGS. 1 and 2.

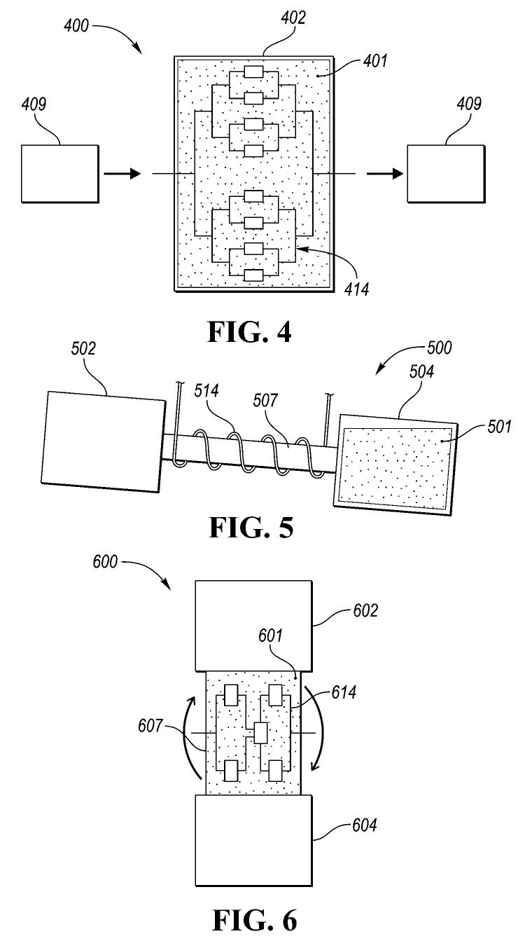

In a non-limiting example shown in FIG. 4, the system or module 400 shows a first container 402 with a heat exchanger 414 having a set of parallel pathways to increase surface area between the heat exchanger 414 and the slurry 401. The direction of the working fluid flow is shown. As the working fluid proceeds through the heat exchanger 414, thermal energy is passed to the slurry 401 or extracted from the slurry 401.

Another non-limiting example is shown in FIG. 5. The system or module 500 includes a first container 502 and a second container 504. A pipe 507 is connecting the containers 502, 504 mechanically and fluidly. A heat exchanger 514 is wrapped around the pipe 507. The system may utilize gravity to transport the slurry 501 from the first container 502 to the second container 504 and vice versa. Rotation of the system 500 may be implemented to use the gravitational force for slurry transport. Rotation or pivoting may be provided via one or more mechanical devices such as swivels or flexible joints. The pivot angle or a degree of rotation around a fixed point the module can turn on may be about, at least about, or at most about 45, 60, 90, 120, 180, 270, or 360 degrees.

In a system or module 600, shown in FIG. 6, a non-limiting example of the latent heat thermal storage system or module is shown to have an internal heat exchanger placement. Specifically, the heat exchange may be provided in the pipe 607 connecting the first container 602 with the second container 604. A gravitational force and/or a pump (not depicted) may be used to transport the slurry 601 between the containers via the pipe 607. The system or module 600 may be rotatable to achieve gravity-driven flow of the slurry 601 through the system.

The working fluid may carry the thermal energy between the latent heat thermal storage systems or modules disclosed herein and one or more apparati such as a heat pump, air conditioner, etc., which are schematically depicted as 409 in FIG. 4. For example, upon demand, a heat pump may extract heat from the disclosed systems by circulating the working fluid through a heat exchanger in the system such that the working fluid absorbs heat from the stored thermal energy. The heated working fluid then travels through the heat pump’s system, where the heat is transferred to a desired location such as a building’s heating system, for example via another heat exchanger. The overall system may be split between an indoor unit and an outdoor unit.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A latent heat storage module comprising:
a first container and a second container structured to contain a slurry;
the slurry comprising a first component configured to retain its liquid phase during operation of the latent heat storage module, and a second component which is a phase change material suspended in the first component;
a device configured to transport the slurry from the first container to the second container; and
a heat exchanger in contact with the device configured to pass heat to or from the slurry.

2. The module of claim 1, wherein the second component is a solid-solid phase change material.

3. The module of claim 1, wherein the phase change material has a phase transition temperature within an operating temperature range of the latent heat storage module.

4. The module of claim 1, wherein the first component is not a phase change material within an operating temperature range of the latent heat storage module.

5. The module of claim 1, wherein the slurry is a viscous gel having a viscosity of about 0.5-20 Pa/s.

6. The module of claim 1, wherein the device is a positive displacement pump.

7. The module of claim 1, wherein the first component is water.

8. The module of claim 1, wherein the second component is an organometallic compound.

9. A latent heat storage system comprising:
a cooling apparatus;
a latent heat storage module in fluid communication with the cooling apparatus comprising:
a mixture comprising a first component configured to retains its liquid phase during operation of the latent heat storage module and a second component which is a phase change material suspended in the first component;
a device configured to mechanically move the mixture from a first area of the module to a second area of the module; and
a heat exchanger, in contact with the device, configured to pass heat to the mixture or extract heat from the mixture while the mixture is in transit between the first area and the second area.

10. The system of claim 9, wherein the mixture is a slurry.

11. The system of claim 9, wherein the device is a screw pump.

12. The system of claim 9, wherein the second component is a solid-solid phase change material.

13. The system of claim 9, wherein the phase change material has a phase transition temperature within an operating temperature range of the latent heat storage module.

14. The system of claim 9, wherein the first component is not a phase change material within an operating temperature range of the latent heat storage module.

15. The system of claim 9, wherein the mixture is a viscous gel having a viscosity of about 0.5-20 Pa/s.

16. The system of claim 9, wherein the cooling apparatus is a heat pump.

17. A latent heat storage module comprising:
first and second containers structured to contain a slurry;
the slurry comprising
a first component configured to retain its liquid phase during operation of the module and
a second component which is a phase change material suspended in the first component configured to change phase during operation of the latent heat storage module; and
a heat exchanger in contact with the slurry configured to pass heat to or from the slurry.

18. The module of claim 17, wherein the module comprises a pivoting component structured to pivot the module with a pivot angle of about 180 degrees.

19. The module of claim 17, wherein the second component is a solid-solid phase change material.

20. The module of claim 17, wherein the phase change material has a phase transition temperature within an operating temperature range of the latent heat storage module.
